(19) United States
(12) Patent Application Publication
(10) Pub. No.: US 2023/0340283 A1
(43) Pub. Date: Oct. 26, 2023

(54) WATERPROOF QUICK-DRYING SELF-ADHESIVE WRITING AND PRINTING MATERIAL AND PREPARATION METHOD THEREOF

(71) Applicant: Shanghai Great K2 Industry Co., Ltd, Shanghai (CN)

(72) Inventor: Biwu ZHAO, Shanghai (CN)

(73) Assignee: Shanghai Great K2 Industry Co., Ltd, Shanghai (CN)

(21) Appl. No.: 17/844,756

(22) Filed: Jun. 21, 2022

(30) Foreign Application Priority Data
Apr. 22, 2022 (CN) 202210427951.1

(51) Int. Cl. C09D 11/03; C09J 7/38

(52) U.S. Cl. CPC C09D 11/03; C09J 7/38; C09J 2301/302; C09J 2301/408; C09J 2467/006; C09J 2475/006

(57) ABSTRACT

A waterproof quick-drying self-adhesive writing and printing material and a preparation method thereof are provided. The material includes: a pressure-sensitive adhesive layer provided with a release layer on its lower surface; and a substrate having a lower surface attached and fixed to the upper surface of the pressure-sensitive adhesive layer and an upper surface coated with a surface coating. The preparation method includes the steps of: S1. adhering a release paper or a release film to the lower surface of a pressure-sensitive adhesive with a desired size, to serve as a base; S2. taking a substrate having the same shape and area as the pressure-sensitive adhesive in S1, and adhering the substrate to the upper surface of the pressure-sensitive adhesive; and S3. uniformly coating the prepared coating solution on the upper surface of the substrate, and drying to obtain a surface coating with a thickness of 3-50 µm.

### CROSS REFERENCE TO THE RELATED APPLICATIONS

[0001.1] This application is based upon and claims priority to Chinese Patent Application No.: 202210427951.1, filed on Apr. 22, 2022, the entire of contents of which are incorporated herein by reference.

### TECHNICAL FIELD

The present application relates to the field of daily necessities, in particular to a waterproof quick-drying self-adhesive writing and printing material and a preparation method thereof.

### BACKGROUND

Writing materials with self-adhesive property are commonly used items in home life and daily office work, have a wide range of uses and are often used as notes, markers and personalized labels, etc.

At present, self-adhesive writing materials on the market are generally as follows:

The first type: color lettering paster; this type of product utilizes the color of a material itself or the surface of the material to display the color. Since the surface cannot absorb ink, it cannot be written with a fountain pen or a neutral pen, nor can it be printed with a traditional printer, and thus the personalization performance of the material will be limited;

The second type: professional printing labels; although this type of label can be printed with a pattern using a dedicated label printer or a wide format printer, it cannot be written with a water-based or neutral pen, nor can it be printed with a home inkjet printer, and thus is inconvenient in term of convenience and home use;

The third type: common waterproof printable self-adhesive materials; such materials can be written or printed, but because the coating is white, it will cover the original surface color of the material and reduce the surface color expression of the material itself;

The fourth type: water-based self-adhesive materials; such materials can be written or printed, and the coating is transparent, but because the coating adopts a water-absorbing resin, they are not waterproof, and the coating will dissolve after contacting with water or moisture.

In summary, it can be seen that current self-adhesive writing materials have the disadvantages that they cannot be directly written, or cannot be printed, or the original surface color of the material is covered.

### SUMMARY

For these reasons, the present application provides a waterproof quick-drying self-adhesive writing and printing material and a preparation method thereof, so as to solve the problems existing in the prior art that the material cannot be directly written, or cannot be printed, or the original surface color of the material is covered.

In order to solve the above problems, the present invention provides the following solutions:

In a first aspect, the present invention provides a waterproof quick-drying self-adhesive writing and printing material, comprising:
a pressure-sensitive adhesive layer provided with a release layer on its lower surface; and
a substrate having a lower surface attached and fixed to the upper surface of the pressure-sensitive adhesive layer and an upper surface coated with a surface coating, wherein the surface coating contains nano-oxide particles as components and has a microporous gap structure on its surface.

Optionally, the nano-oxide particles are nano-alumina and/or nano-silica particles having a particle size of 3-200 nm.

Optionally, the surface coating has a thickness of 3-50 µm.

Optionally, the components of the surface coating further contain one or more of a binder, an ultraviolet absorber, and an antioxidant.

In a second aspect, the present invention provides a preparation method of a waterproof quick-drying self-adhesive writing and printing material, comprising the steps of:
S1. adhering a release paper or a release film to the lower surface of a pressure-sensitive adhesive with a desired size, to serve as a base;
S2. taking a substrate having the same shape and area as the pressure-sensitive adhesive in S1, and adhering the substrate to the upper surface of the pressure-sensitive adhesive to make the substrate fit with the shape of the pressure-sensitive adhesive; and
S3. uniformly coating the prepared coating solution on the upper surface of the substrate, and drying to obtain a surface coating with a thickness of 3-50 µm, namely, the waterproof quick-drying self-adhesive material, wherein the coating solution contains a solvent and nano-oxide particles as components.

Optionally, the solvent in S3 includes PVA polyvinyl alcohol, polyacrylic acid, PMA propylene glycol methyl ether acetate, and ethanol.

Optionally, the nano-oxide particles in S3 are nano-alumina and/or nano-silica particles, and have a solid content of 10-50%.

Optionally, the coating solution further contains a functional aid, and the functional aid includes a binder, an ultraviolet absorber, and an antioxidant.

Optionally, the substrate includes: polyethylene terephthalate (PET) film, polyvinyl chloride (PVC) film, polyurethane (PU) film, polypropylene (PP) film, and plastic-coated paper, as materials.

Optionally, in S3, the drying is performed at a temperature of >100° C. for a duration of ≥1 min.

Compared with the prior art, the present application at least has the following beneficial effects:

(1) The waterproof quick-drying self-adhesive writing and printing material provided by present application contains nano-oxide particles, specifically nano-alumina particles and/or nano-silica particles in the coating coated on the surface, and can be waterproof while absorbing ink by utilizing the microporous structure of the nano-alumina particles and/or nano-silica particles. The waterproof quick-drying self-adhesive writing and printing material is able to display the natural color of the surface of the substrate due to the transparency of the nano-alumina particles and/or nano-silica particles. The demand for pen writing, printing, waterproofing, fashion and the like in the use of personalized home labels has been expanded. The waterproof quick-drying self-adhesive writing and printing material can be cut into customized shapes due to the cutability of the plastic film. The pressure-sensitive self-adhesive design ensures that no special skills are required during installation and use, and it is easy to apply and remove, easy to install in various occasions such as gifts, furniture, stationery, storage, etc., and is convenient and simple. The underlying release structure ensures that the writing material provided by the present invention has its own substrate, which is convenient for lettering or cutting into any shape, and easy to carry after lettering.

(2) The waterproof quick-drying self-adhesive writing and printing material provided by this application can not only meet the lettering requirements, but also meet the writability and printability properties that color lettering products do not have, compared with the color lettering paster products. It can output patterns with a home inkjet printer and draw lines with a home cutting plotter, which solves the problem that professional label pasters must use a dedicated equipment to output patterns, compared with the professional label printing products. As the coating of the waterproof quick-drying self-adhesive writing and printing material provided by this application is a transparent coating, it solves the defect that the coating of a common waterproof printing self-adhesive material will cover the original film color and texture, while maintaining all the properties of common waterproof printable materials, compared with the common waterproof printable self-adhesive material. It overcomes the defect that water-based self-adhesive materials are not waterproof and moisture-proof, and can be perfectly waterproof and moisture-proof, compared with the water-based self-adhesive materials.

(3) The waterproof quick-drying self-adhesive writing and printing material provided by this application has a very broad application prospect in home life and daily office situations. Since most of the existing self-adhesive writing materials on the market cannot simultaneously meet the core personalized requirements of writing with pen (including oil-based, water-based and neutral pens), being suitable for home inkjet printing, moisture-proofing and waterproofing, maintaining the original film surface color, water-absorbing and quick-drying, cutability, and fast pasting, etc., the usage scenarios are greatly limited. The present invention fully solves the above problems and has an extremely broad market prospect. The writing material provided by this application can simultaneously meet the core requirements for personalized decorative pasters: maintaining the surface color of the material itself, writing with pen (including water-based, neutral and oil-based pens), printability, lettering, moisture-proofing and waterproofing, easy to install, and other properties.

### BRIEF DESCRIPTION OF THE DRAWINGS

In order to more intuitively illustrate the prior art and the present application, several exemplary drawings are given below. It should be understood that the specific shapes and configurations shown in the drawings should generally not be regarded as limitations when implementing this application. For example, those skilled in the art are capable of easily making routine adjustments or further optimizations to the addition/decrease/attribution division, specific shapes, position relationships, connection means, size ratio relationships of certain units (components), etc., based on the technical concept disclosed in this application and exemplary drawings.

FIG. 1 is a schematic diagram of a side structure of a waterproof quick-drying self-adhesive writing and printing material provided according to an embodiment of this application;

FIG. 2 is a schematic diagram of a top structure of a waterproof quick-drying self-adhesive writing and printing material provided according to an embodiment of this application.

### DESCRIPTION OF REFERENCE NUMERALS

In drawings: 1-pressure-sensitive adhesive layer, 2-release layer, 3-substrate, 4-surface coating.

### DETAILED DESCRIPTION OF THE EMBODIMENTS

The present application will be further described in detail below in conjunction with the drawings through specific embodiments.

In the description of this application, “a plurality of” means two or more, unless otherwise stated. The terms “first”, “second”, “third”, etc. in the present application are intended to distinguish the objects they refer to, and do not have special meanings in terms of technical connotations (for example, they should not be understood as an emphasis on importance degree or order, etc.). The expressions “including”, “comprising”, “having”, etc. also mean “not limited to” (certain units, components, materials, steps, etc.).

The wordings “upper”, “lower”, “left”, “right”, “middle”, etc. referred to herein are usually for the convenience of intuitive understanding with reference to the drawings, rather than an absolute limitation on the position relationships in actual products. The changes of these relative position relationships should also be considered to be within the scope of this application, without departing from the technical concept disclosed in this application.

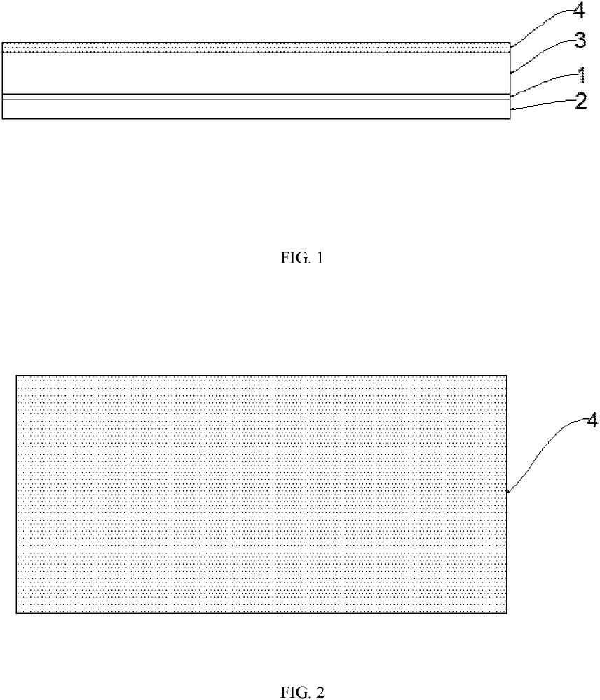

An embodiment of the present invention provides a waterproof quick-drying self-adhesive writing and printing material, as shown in FIG. 1 and FIG. 2, the material comprising:
a pressure-sensitive adhesive layer 1 provided with a release layer 2 on its lower surface; and
a substrate 3 having a lower surface attached and fixed to the upper surface of the pressure-sensitive adhesive layer 1 and an upper surface coated with a surface coating 4, wherein, the surface coating 4 contains coatings and nano-alumina particles and/or nano-silica particles having a particle size of 3-200 nm as components. The surface coating 4 has a microporous gap structure on its surface, and generally has a thickness of 3-50 µm. As the nano-alumina particles and/or nano-silica particles have good transparency and a large specific surface area, the surface coating containing them has a microporous gap structure which can not only absorb liquids such as solvents, oil and water, but also adsorb pigments and dyes in ink, so that the color can be fixed to meet the requirements for writing with pen and printability. In addition, as the nano-alumina particles and/or nano-silica particles themselves are insoluble in solvents, oil or water, the coating itself will not be dissolved, so that the material can be moisture-proof and waterproof while absorbing water. Due to the good transparency of the nano-alumina particles and/or nano-silica particles, the coating will not cover the texture and color of the surface of the substrate (such as a film layer) itself. In addition, a binder, an ultraviolet absorber, an antioxidant and other aids may be added to the coating solution when applying the coating, to achieve different performance requirements, depending on the different requirements for indoor and outdoor use.

The substrate 3 bonded to the surface coating 4 is usually a different plastic film (including but not limited to PET, PVC, PP, etc.) or a plastic-coated paper, and can be selected from a transparent film or a colored material, or a surface-treated substrate, such as metal-plated gold and silver, glitter, laser, etc. The substrate 3 has an upper surface bonded to the surface coating 4, and a lower surface bonded to the pressure-sensitive adhesive layer 1. The substrate 3 usually has a thickness of 20-200 µm, which can be adjusted appropriately according to special requirements.

The release layer 2 provided on the lower surface of the pressure-sensitive adhesive layer 1 is usually a release paper or a release film, which is a kind of auxiliary material, can not only be used for release, but also can be used as a substrate during lettering or cutting. The release layer 2 should be removed during use.

An embodiment of the present invention also provides a preparation method of a waterproof quick-drying self-adhesive writing and printing material, comprising steps of:
S1. adhering a release paper or a release film to the lower surface of a pressure-sensitive adhesive with a desired size, to serve as a base;
S2. taking a substrate having the same shape and area as the pressure-sensitive adhesive in S1 and adhering the substrate to the upper surface of the pressure-sensitive adhesive to make the substrate fit with the shape of the pressure-sensitive adhesive; and
S3. uniformly coating the prepared coating solution on the upper surface of the substrate, and drying (at a temperature above 100° C. for a duration of not less than 1 min) to obtain a surface coating with a thickness of 3=50 µm, namely, the waterproof quick-drying self-adhesive material. Wherein, the coating solution contains a solvent and nano-oxide particles as components, and the nano-oxide particles are specifically nano-alumina particles and/or nano-silica particles having a particle size of 3-200 nm and have a solid content of 10-50%. A functional aid such as a binder, an ultraviolet absorber, an antioxidant and other aids may also be added to the coating solution to achieve different performance requirements as necessary. The solvent in the coating solution is one or more of PVA polyvinyl alcohol, polyacrylic acid, PMA propylene glycol methyl ether acetate, ethanol, other alcohols or other organic solvents. A volatile solvent should be selected, which will evaporate after drying the coating solution on the upper surface of the substrate, thus leaving a coating, and the volatile solvent may allow the impurity content in the coating to be as low as possible.

The technical features of the foregoing embodiments can be combined arbitrarily (as long as there is no conflict in the combination of these technical features). For conciseness of description, not all possible combinations of the technical features of the foregoing embodiments are described. However, those embodiments that are not explicitly written should also be considered to be within the scope of this specification.

The present application has been described more specifically and in detail above through the general description and specific embodiments. It should be understood that, based on the technical concept of the present application, some conventional adjustments or further innovations can also be made to these specific embodiments, and the technical solutions obtained by these conventional adjustments or further innovations also fall within the scope of the claims of the present application as long as they do not depart from the technical concept of the present application.

What is claimed is:

1. A waterproof quick-drying self-adhesive writing and printing material, comprising:
a pressure-sensitive adhesive layer provided with a release layer on a lower surface of the pressure-sensitive adhesive layer;
a substrate having a lower surface attached and fixed to an upper surface of the pressure-sensitive adhesive layer and an upper surface coated with a surface coating, wherein the surface coating contains nano-oxide particles as components and has a microporous gap structure on a surface of the surface coating.

2. The waterproof quick-drying self-adhesive writing and printing material according to claim 1, wherein the nano-oxide particles are nano-alumina and/or nano-silica particles having a particle size of 3-200 nm.

3. The waterproof quick-drying self-adhesive writing and printing material according to claim 1, wherein the surface coating has a thickness of 3-50 µm.

4. The waterproof quick-drying self-adhesive writing and printing material according to claim 1, wherein the components of the surface coating further contain one or more of a binder, an ultraviolet absorber, and an antioxidant.

5. A preparation method of a waterproof quick-drying self-adhesive writing and printing material, comprising steps of:
S1. adhering a release paper or a release film to a lower surface of a pressure-sensitive adhesive with a desired size, to serve as a base;
S2. taking a substrate having a same shape and area as the pressure-sensitive adhesive in S1, and adhering the substrate to an upper surface of the pressure-sensitive adhesive to make the substrate fit with the shape of the pressure-sensitive adhesive; and
S3. uniformly coating a prepared coating solution on an upper surface of the substrate to obtain a coated substrate, and drying the coated substrate to obtain a surface coating with a thickness of 3 50 µm, wherein the surface coating is the waterproof quick-drying self-adhesive writing and printing material, wherein the prepared coating solution contains a solvent and nano-oxide particles as components.

6. The preparation method of the waterproof quick-drying self-adhesive writing and printing material according to claim 5, wherein the solvent in S3 includes polyvinyl alcohol (PVA), polyacrylic acid, propylene glycol methyl ether acetate (PMA), and ethanol.

7. The preparation method of the waterproof quick-drying self-adhesive writing and printing material according to claim 5, wherein the nano-oxide particles in S3 are nano-alumina and/or nano-silica particles, and the nano-oxide particles have a solid content of 10-50%.

8. The preparation method of the waterproof quick-drying self-adhesive writing and printing material according to claim 5, wherein the prepared coating solution further contains a functional aid, and the functional aid includes a binder, an ultraviolet absorber, and an antioxidant.

9. The preparation method of the waterproof quick-drying self-adhesive writing and printing material according to claim 5, wherein the substrate includes: a polyethylene terephthalate (PET) film, a polyvinyl chloride (PVC) film, a polyurethane (PU) film, a polypropylene (PP) film, and a plastic-coated paper, as materials.

10. The preparation method of the waterproof quick-drying self-adhesive writing and printing material according to claim 5, wherein in S3, the step of drying is performed at a temperature of > 100° C. for a duration of ≥ 1 min.
